(19) United States
(12) Patent Application Publication
(10) Pub. No.: US 2025/0061245 A1
(43) Pub. Date: Feb. 20, 2025

(54) DESIGN AND MANUFACTURING OF MECHANICAL COMPONENT USING OPTIMIZATION ENGINE

(71) Applicant: Textron Systems Corporation, Hunt Valley, MD (US)

(72) Inventors: Wesley Aaron Chapkin, Rockville, MD (US); Michael Robert Favaloro, Amesbury, MA (US); William Bignon Agassounon, Lexington, MA (US); Ryan Charles Truhn, Boston, MA (US)

(21) Appl. No.: 18/800,443

(22) Filed: Aug. 12, 2024

Related U.S. Application Data
(60) Provisional application No. 63/532,507, filed on Aug. 14, 2023.

(51) Int. Cl. G06F 30/17

(52) U.S. Cl. CPC G06F 30/17

(57) ABSTRACT

In a method for designing and producing a mechanical component for an application, application requirements and application variables are provided to an optimization engine, wherein the application requirements describe required features and the application variables describe features that can be varied to arrive at an optimal design. The optimization engine is operated using the application requirements and application variables to produce a manufacturing specification for the mechanical component, which includes specific values for the application variables corresponding to an optimal design. The mechanical component is then manufactured according to the manufacturing specification. The optimization engine may use a genetic algorithm to generate and evaluate a large number of candidate designs and thus quickly and efficiently produce superior application-specific components.

### BACKGROUND

The disclosure is directed to the field of manufacturing mechanical components.

### SUMMARY

A method is disclosed for designing and producing a mechanical component for use in an application, such as a covering for an aperture of an air-vehicle nosecone. Application requirements and application variables are provided to an optimization engine, wherein the application requirements describe features of the mechanical component required by the application, and the application variables describe features of the mechanical component that can be varied to arrive at an optimal design. The optimization engine is operated using the application requirements and application variables to produce a manufacturing specification for the mechanical component, wherein the manufacturing specification includes specific values for the application variables corresponding to an optimal design. The mechanical component is then manufactured according to the manufacturing specification. The optimization engine may use a so-called genetic algorithm to generate and evaluate a large number of candidate designs, many of which may be non-intuitive to human designers, and thus quickly and efficiently produce superior application-specific components.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is a schematic depiction of an example application for the disclosed design and manufacturing method;

FIG. 2 shows renderings of example unit cells of cell-based structures;

FIG. 3 is an example window component in the form of a strut lattice;

FIG. 4 is a rendering of a body-centered cubic (BCC) unit cell;

FIGS. 5 and 6 are renderings of planar lattice structures;

FIG. 7 is rendering of a surface-based lattice structure;

FIG. 8 is a rendering of a Schwarz P-Surface unit cell; and

FIG. 9 is a high-level flow diagram of a design and manufacturing method.

### DETAILED DESCRIPTION

### Overview

The disclosure is directed to a method of manufacturing a mechanical component, including a mechanical component used in larger assembly. In one example, it is directed to a thermal barrier structure of an airborne vehicle such as an aperture for a nosecone or nosecap, or a covering for an aperture of a heatshield for an airborne vehicle such as a nosecone. The method generally involves use of a certain type of design tool (“tool”) that operates according to user-provided constraints to generate and analyze many candidate designs, then reduce the candidates down to a smaller set subject to additional analysis and selection (process may be iterated with adjustment of constraints as necessary). A selected design is described by a tool-generated specification that feeds into manufacturing, e.g., additive manufacturing, of the component.

### Embodiments

The technique is described with reference to a particular example application, which is the design and manufacture of a covering for a radio-frequency, electro-optical, and/or infrared (RF/EO/IR) aperture of a nose cone heatshield. The covering is to provide an acceptable level of thermal protection while being highly transmissive with respect to RF and/or EO/IR signals used by internal components of the airborne vehicle.

In the present description, the covering is also referred to as a “window” for convenience.

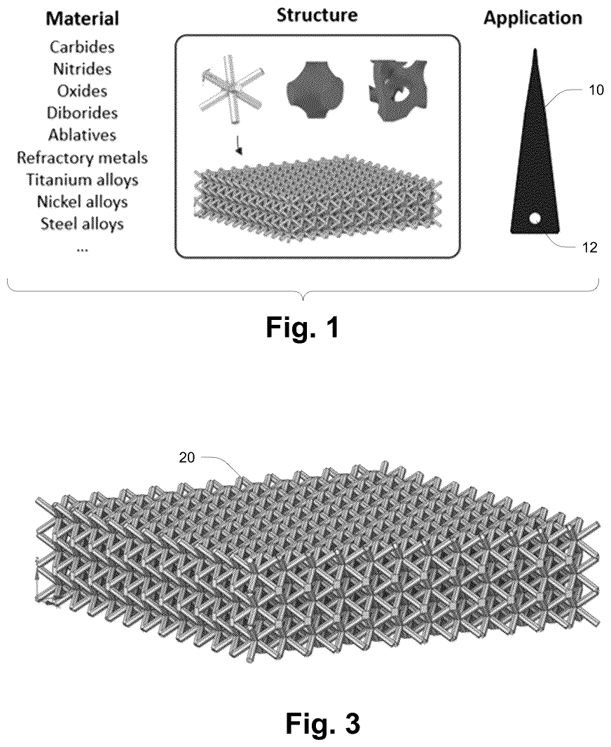

FIG. 1 illustrates the example application, which is a covering for a nosecone heatshield 10 having a small RF/EO/IR aperture 12. Candidate materials are listed, and aspects of potential structures are also shown; these are described in more detail below. As also described more below, various constraints of this application are provided to an optimization process that develops a specification for a covering having certain structure.

The following are important aspects of the challenging process of designing coverings/windows for such applications:
Max operating temperatures for RF-transparent materials peak at a temperature greater than 1000° C., e.g. in the range 1200-2400° C.
Stochastically porous windows have electrical-mechanical performance tradeoffs
Windows are optimized for transmission over a narrow wavelength band
Manufacturing limitations restrict larger-sized windows
Window materials are often single-use and scrapped after sustaining damage

The disclosed technique can generate non-intuitive high-temperature window designs, including multi-spectral windows and functionally graded windows with ordered porosity. Several examples using cell-based structures are described, including an array of basic cell shapes and example windows for some of these.

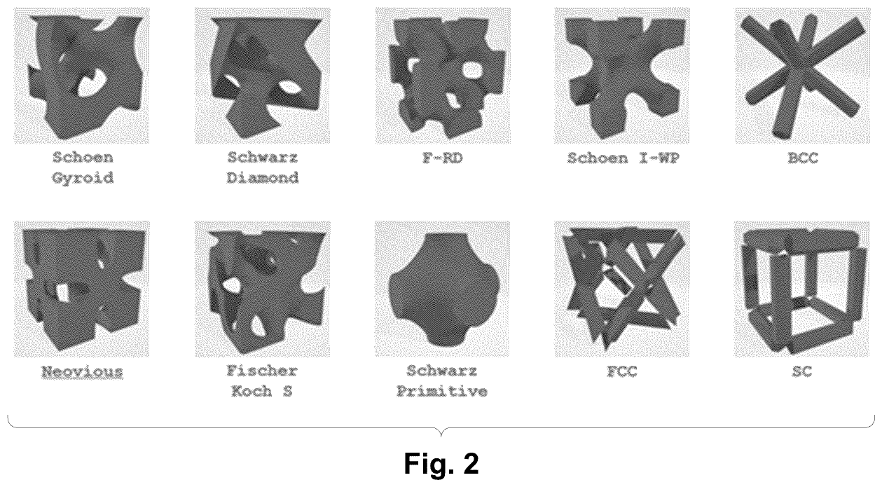

FIG. 2 shows a variety of possible unit cell types, each having corresponding three-dimensional structure and identified by a name as shown (Schoen Gyroid, Schwarz Diamond, etc.).

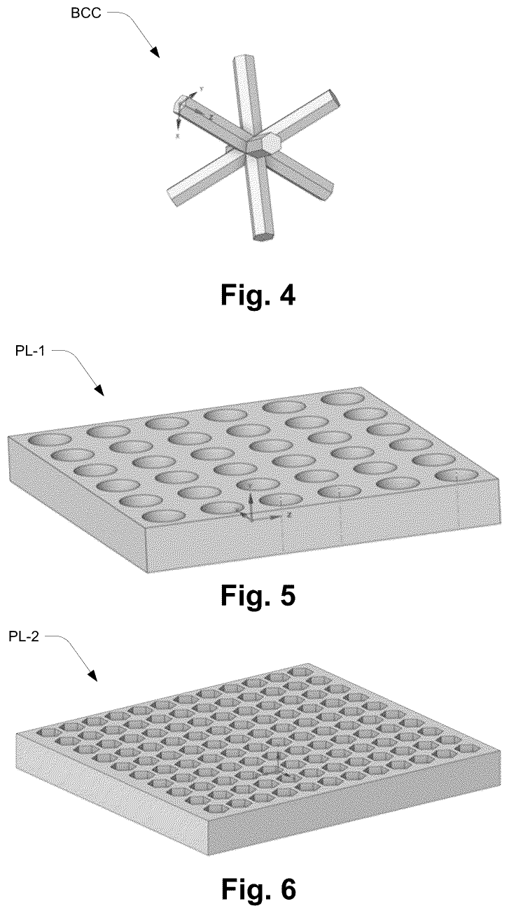

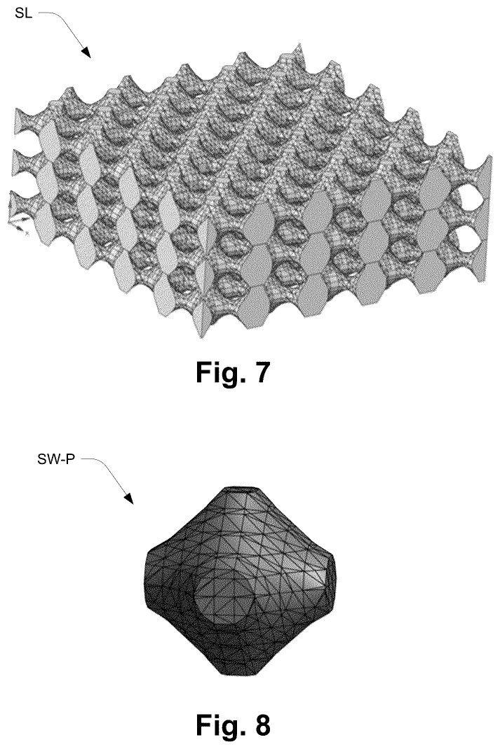

FIG. 3 is an example window 20 formed as a “strut lattice” using the body-centered cubic (BCC) unit cell, included in FIG. 2 and also shown in more detail in FIG. 4. FIGS. 5 and 6 illustrate two forms of planar lattices PL-1 and PL-2. FIG. 7 is an example surface-based lattice SL. FIG. 8 is an example of a Schwarz P-Surface unit cell SW-P.

In the above examples, closed-cell structures of any of a variety of materials, such as but not limited to silicon nitride, may extend operational envelope of RF-transparent windows to very high operating temperature (e.g., beyond 1700° C.). A support structure, or truss, may provide optimized performance via additive manufacturing to resist higher temperature, decreased material mass, and more agile/adaptable modeling to user constraints.

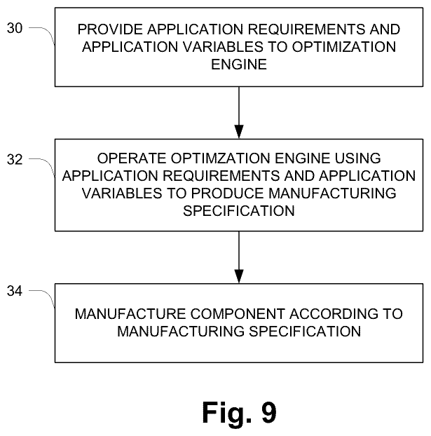

FIG. 9 is a high-level flow diagram of a process of designing and producing a mechanical component (e.g., a covering/window) for use in an application (e.g., heatshield aperture). The process includes design steps using a computer-based optimization engine, i.e., a computer program configured and operative to produce a component design (manufacturing specification) based on certain requirements and variables supplied thereto.

At 30, in a first step, application requirements and application variables are provided to the optimization engine. The application requirements describe features of the mechanical component required by the application, and the application variables describe features of the mechanical component that can be varied to arrive at an optimized design (illustrative examples given below).

At 32, the optimization engine is then operated using the application requirements and application variables to produce a manufacturing specification for the mechanical component. The manufacturing specification includes specific values for the application variables corresponding to the optimized design.

At 34, the mechanical component is manufactured according to the manufacturing specification. In one example, the component is made using an additive manufacturing process with specified starting materials.

In the above, the term “optimized design” refers to a design that is produced by an iterative aspect of the optimization engine, which may be based on a genetic algorithm or similar evolution technique for example.

The following are example inputs to the optimization engine at step 30 of FIG. 9:
Application requirements: Also referred to as boundary conditions or operational requirements, these can include items such as the following: outer mold line (size and shape), melting point (or other transition temperatures such as glass, sublimation, oxidation . . . ), erosion/ablation resistance (i.e., how it holds its shape over time), heat flux, duration of high-temperature operation, etc. These requirements form the basis for the objective function used by the design tool to evaluate relative performance of candidate designs.
Application variables: These are design variables that are traded during an optimization process and can include things such as material type, dielectric/optical properties (RF, EO/IR), thermal conductivity, specific heat, linear thermal expansion, emissivity, electrical conductivity, strength (tensile, compressive, shear, flexural), modulus, Poisson ratio, toughness, hardness, morphology, porosity, etc.

The inputs at 30 are either supplied by the user and are use-specific (application requirements) or they may be more generally available (e.g., stored in a material database accessible to the engine) and are use-agnostic (application variables).

Example outputs at 32 (manufacturing specification(s)) include CAD files, finite element analyses (structural, thermal, electrical . . . ), Pareto fronts mapping relevant design space, etc.

During the operation step 32, application variables are traded by the optimization engine at a macro/component level, with constitutive elements defined from a property database of some kind. In one example, an individual voxel may be defined as element/material X with its set of properties, and an adjacent voxel may be defined as element/material Y (and so on and so forth) until an entire design volume is filled. That entire composite/hybrid material has (heretofore undefined) macroscopic properties dependent upon the already defined (and available in handbooks) materials that compose it.

Additionally, manufacturing constraints may also be used to better bound the optimization problem. For example, a manufacturing process X might be limited to a component size Y or a resolution Z, or deposition at temperatures above a temperature W, etc.

In operation at step 32 of FIG. 9, the optimization engine employs an optimization algorithm (e.g., a genetic algorithm) that randomly generates a set number of different structures. The performance of the structures relative to a specific application (e.g., heatshield window) are quantified by an objective function. The algorithm iterates on the generated structures over many cycles to map out a design space and identify superior designs for that application, a process that is somewhat analogous to the process of natural selection. Eventually, a Pareto front of design is created, which is a grouping of the “best” or “nondominated” structures with respect to design criteria.

The specifics of how the algorithm works may depend on the specific design task. In one example, a genetic algorithm is used which initially assigns material randomly in a design volume. It drops many points spanning all different types of designs (e.g., some metal, some polymer, some ceramic, some composite, some with porosity, some layered, some with fibers, etc.). It iterates on these by identifying better performing designs (based on objectives set by the user, e.g., make it stronger, higher temperature, more transparent . . . ) and “mutating” these objectives, i.e., replacing or shifting elements to see if it improves or decreases performance. Each design populates a larger design space in which it is possible to highlight the “best” ones with a Pareto front.

For the design and manufacture of an aperture covering in particular, the size of the unit cells for the structure are generally constrained to be some function of the EO/IR operating wavelength (e.g., a certain fraction thereof), in order to be as transparent as possible at the operating frequency. This constraint may set an upper bound for what the structure can look like.

The following describes an overall electrical modeling/testing pipeline:
1. Generate physical test specimens of varying material, thickness, structure, etc.
2. Test specimens using an electrical testing setup (waveguide, focused beam, resonant cavity, etc.) for a wide range of frequencies to retrieve dielectric properties and scattering parameters.
3. Replicate test setup in a simplified modeling space to generate theoretical results.
4. Iterate on model to improve accuracy by adjusting results to the theoretical data.
5. Use the model to generate much larger data set of structures with their corresponding properties with much finer changes in material, thickness, structure, etc.
6. Structures are down selected from initial parameters as defined by the user. This process is done using machine learning to generate appropriate options that fit the criteria.
7. The structures are then exported to a more advanced model where they are integrated into the vehicle (e.g., nosecone) and analyzed in its application setting. In one arrangement, this simulation puts the vehicle at its desired location with respect to a ground antenna counterpart, and a more detailed simulation is executed to study the gain of the antenna as it is spinning and moving through the atmosphere.

While various embodiments of the invention have been particularly shown and described, it will be understood by those skilled in the art that various changes in form and details may be made therein without departing from the scope of the invention as defined by the appended claims.

What is claimed is:

1. A method of designing and producing a mechanical component for use in an application, comprising:
providing application requirements and application variables to an optimization engine, the application requirements describing features of the mechanical component required by the application, the application variables describing features of the mechanical component that can be varied to arrive at an optimal design;
operating the optimization engine using the application requirements and application variables to produce a manufacturing specification for the mechanical component, the manufacturing specification including specific values for the application variables corresponding to the optimal design; and
manufacturing the mechanical component according to the manufacturing specification.

2. The method of claim 1, wherein mechanical component is a covering for an aperture of a nosecone heatshield, the covering having application requirements to provide a predetermined level of thermal protection and a predetermined level of transmissivity for radio-frequency and/or electro-optical/infrared signals.

3. The method of claim 2, wherein the application requirements include a maximum operating temperature in a range greater than 1000° C.

4. The method of claim 2, wherein the covering is one of (1) a multi-spectral window having transmissivity at multiple wavelengths, and (2) a functionally graded window with ordered porosity.

5. The method of claim 1, wherein the application requirements include one or more of size and shape, melting point or other transition temperatures, erosion/ablation resistance, heat flux, and duration of high-temperature operation, the application requirements forming a basis for an objective function used by the optimization engine to evaluate relative performance of candidate designs.

6. The method of claim 1, wherein the application variables include one or more of material type, dielectric/optical properties, thermal conductivity, specific heat, linear thermal expansion, emissivity, electrical conductivity, strength, modulus, Poisson ratio, toughness, hardness, morphology, and porosity.

7. The method of claim 1, wherein the manufacturing specification includes one or more of computer-aided design files, finite element analyses, and Pareto fronts mapping relevant design space.

8. The method of claim 1, wherein the application variables are traded by the optimization engine at a macro/component level, with constitutive elements defined from a property database, including definition of individual voxels as respective distinct materials with respective properties until an entire design volume for the mechanical component is filled, such that a resulting composite/hybrid material has macroscopic properties dependent upon known properties of the distinct materials.

9. The method of claim 1, wherein the application requirements include manufacturing constraints of a manufacturing process used in the manufacturing step.

10. The method of claim 1, wherein the optimization engine employs an optimization algorithm that randomly generates a set number of different structures and quantifies performance of the structures relative to the application using an objective function, the optimization algorithm iterating on the generated structures over many cycles to map out a design space and identify best-performing designs for the application.

11. The method of claim 10, wherein the iterating results in creation of a Pareto front of designs being a grouping of the best-performing designs with respect to the application requirements and application variables.

12. The method of claim 10, wherein the optimization algorithm is a genetic algorithm which initially assigns material randomly in a design volume and drops points spanning different types of designs relative to at least material, then iterates by identifying better performing designs based on objectives set by a user.

13. The method of claim 10, wherein the structures are cell-based structures having repetitions of respective unit cells.

14. The method of claim 13, wherein the cell-based structures include a planar structured lattice.

15. The method of claim 1, being part of an overall modeling and testing pipeline including:
generating physical test specimens of varying material, thickness, and structure;
testing the specimens using an electrical testing setup for a wide range of operating frequencies to retrieve dielectric properties and scattering parameters;
replicating the testing setup in a simplified modeling space to generate theoretical results;
iterating on a model to improve accuracy by adjusting results to theoretical data;
using the model to generate a larger data set of structures with corresponding properties with finer changes in material, thickness, and structure;
down-selecting structures from initial parameters as defined by a user; and
exporting the structures to a more advanced model where they are integrated into an application and analyzed in an application setting.

16. A mechanical component for use in an application, the mechanical component being made according to a process including:
providing application requirements and application variables to an optimization engine, the application requirements describing features of the mechanical component required by the application, the application variables describing features of the mechanical component that can be varied to arrive at an optimal design;
operating the optimization engine using the application requirements and application variables to produce a manufacturing specification for the mechanical component, the manufacturing specification including specific values for the application variables corresponding to the optimal design; and
manufacturing the mechanical component according to the manufacturing specification.

17. The mechanical component of claim 16, being a covering for an aperture of a nosecone heatshield, the covering having application requirements to provide a predetermined level of thermal protection and a predetermined level of transmissivity for radio-frequency and/or electro-optical/infrared signals.

18. The mechanical component of claim 17, wherein the covering is one of (1) a multi-spectral window having transmissivity at multiple wavelengths, and (2) a functionally graded window with ordered porosity.

19. The mechanical component of claim 16, formed as a cell-based structure having repetitions of respective unit cells.

20. The mechanical component of claim 19, wherein the cell-based structure is a planar structured lattice.
